(19) United States
(12) Patent Application Publication
(10) Pub. No.: US 2018/0015573 A1
(43) Pub. Date: Jan. 18, 2018

(54) ALUMINUM-BASED METALLIC GLASS CLADDING LAYER AND PREPARATION METHOD THEREOF

(71) Applicant: NATIONAL KEY LABORATORY FOR REMANUFACTURING, Beijing (CN)

(72) Inventors: Xiaoming WANG, Beijing (CN); Sheng ZHU, Beijing (CN); Yao ZHANG, Beijing (CN); Bojun YANG, Beijing (CN); Guofeng HAN, Beijing (CN); Qiwei WANG, Beijing (CN); Zhiqiang REN, Beijing (CN); Yongxing CHEN, Beijing (CN); Chaoji ZHOU, Beijing (CN)

(21) Appl. No.: 15/373,516

(22) Filed: Dec. 9, 2016

(30) Foreign Application Priority Data
Jul. 18, 2016 (CN) 201610565974.3

(51) Int. Cl. B23K 35/28; C22C 21/00; B23K 26/34; C22C 45/08; B22F 1/00

(52) U.S. Cl. CPC B23K 35/286; C22C 45/08; B22F 1/0014; B23K 26/34; C22C 21/00

(57) ABSTRACT

The present invention discloses an aluminum-based metallic glass cladding layer and a preparation method thereof. The aluminum-based metallic glass cladding layer takes aluminum-based amorphous alloy powder as a raw material and is prepared by a magnetic field stirring laser cladding molding technology; the aluminum-based amorphous alloy powder consists of the following elements: 5 wt %-8 wt % of Ni, 3 wt %-6 wt % of Y, 1 wt %-5 wt % of Co, 0.5 wt %-3 wt % of La and Al as balance; the particle size range of the aluminum-based amorphous alloy powder is 25-71 mum; and the oxygen content of the aluminum-based amorphous alloy powder is below 1,000 ppm. The aluminum-based amorphous alloy powder adopted by the present invention has high degree of sphericity, good flowability and moderate particle size; the added alloy elements have the characteristics of strong amorphous forming capability and stable structure; and meanwhile, the aluminum-based metallic glass cladding layer has excellent mechanical property, wear resistance property and corrosion resistance property.

### TECHNICAL FIELD

The present invention belongs to the technical field of a cladding forming technology and particularly relates to an aluminum-based metallic glass cladding layer and a preparation method thereof.

### BACKGROUND

Compared with the traditional crystalline materials, metallic glass has various excellent properties, such as high strength, high hardness, great elastic strain limit, high corrosion resistance, excellent magnetism, etc. Additionally, the metallic glass attracts much attention from material science and industry communities due to unique structure, efficient preparation process, good material property and wide application prospect of the metallic glass. However, as the critical cooling rate of common amorphous materials is very high (about 10⁶K/s), most of the common amorphous materials can be adopted to only prepare stripe-shaped or powder-shaped samples with micron-range thickness, thereby greatly limiting the application scope of the common amorphous materials.

Relative to iron-based alloy, nickel-based alloy and the like with stronger glass forming ability, the amorphous forming ability of aluminum-based metallic glass is limited, and the aluminum-based metallic glass belongs to a marginal metallic glass system. Therefore, an amorphous aluminum alloy material with high property is more difficultly prepared and is less researched at home and abroad.

Compared with common aluminum alloy materials, most of aluminum-based amorphous alloys have the characteristics of low density, high modulus, more than 1,000 MPa of tensile strength, etc. In addition, due to high chemical homogeneity, the aluminum-based amorphous alloys have almost no crystal boundary, dislocation and the like and can realize solid solution of a large number of corrosion-resistance elements. Therefore, the aluminum-based amorphous alloys have excellent corrosion resistance. Therefore, an aluminum-based metallic glass protection layer has important research significance and wide application prospect.

### SUMMARY

The present invention aims at solving the above-mentioned problems and provides an aluminum-based metallic glass cladding layer with excellent surface function and mechanical property and a preparation method thereof.

In order to achieve the above-mentioned objective, the present invention adopts a technical solution as follows: the aluminum-based metallic glass cladding layer takes aluminum-based amorphous alloy powder as a raw material and is prepared by a magnetic field stirring laser cladding molding technology.

The aluminum-based amorphous alloy powder consists of the following elements: 5 wt %-8 wt % of Ni, 3 wt %-6 wt % of Y, 1 wt %-5 wt % of Co, 0.5 wt %-3 wt % of La and Al as balance.

As a preference, the above-mentioned aluminum-based amorphous alloy powder consists of the following elements:6 wt %-7 wt % of Ni, 4 wt %-5 wt % of Y, 2 wt %-3 wt % of Co, 1 wt %-2wt % of La and Al as balance.

Further, the particle size range of the aluminum-based amorphous alloy powder is 25 -71 mum. The flowability is poor if the particle size of the powder is too small, thereby causing quite serious burning loss in a cladding process, and the prepared cladding layer is not uniform, thereby being difficult for cladding forming; and metallic compound phases such as Al—Ni—Y and the like exist if the particle size of the powder is too big, thereby being conductive to amorphous forming.

Further, the oxygen content of the aluminum-based amorphous alloy powder is below 1,000 ppm. Infusible black oxide (the main element is aluminum oxide with about 2,050 DEG C of melting point) inclusions are easily generated inside the cladding layer in the cladding process if the oxygen content of the powder is higher, thereby causing negative effect on the performance of the cladding layer.

According to the preparation method of the aluminum-based metallic glass cladding layer, the aluminum-based amorphous alloy powder is cladded on a matrix by the magnetic field stirring laser cladding molding technology.

The above magnetic field stirring laser cladding molding technology has specific methods as follows: the matrix to be cladded is placed in an annular stirring magnetic field, so that the matrix generates a rotating magnetic field on the horizontal plane of a molten pool under the lasting stirring action of magnetic field force in a cladding forming process, so as to be capable of exerting the lasting stirring action of the magnetic field force on the molten pool, a coaxial powder-feed YG: Nd solid laser is vertical to the surface of the matrix, and a robot controls reciprocating motion for multi-path multi-layer cladding forming. The molten pool is protected by side-blown argon gas in the cladding process.

The specific process parameters are as follows: laser power: 1,700-2,400 W, scanning speed: 3.5-7 mm/s, spot diameter: 3mm, powder feeding rate: 6-8 g/min, frequency of the magnetic field: 15-35 Hz and exciting current: 10-50 A.

The cladding time is 10-15 s at every time, and the cladding interval is 120-180 s. The cladding interval aims at reducing accumulation of heat in the matrix and the cladding layer, preventing melting collapse of an accumulation layer and alleviating accumulation of thermal stress in the cladding layer.

Further, the magnetic field stirring laser cladding molding technology also includes setting a cladding forming path: first, carrying out longitudinal single-path cladding, then choosing an appropriate amount of overlap for horizontal cladding, setting the length and overlap times of every single-path cladding according to the length and the width of the designed cladding layer, doing repeating motion and accumulating layer by layer, so as to form the cladding layer with a certain thickness finally, wherein the amount of overlap is 30%-50%; the length of the cladding layer is 50-70 mm, the width of the cladding layer is 15-25 mm, and the thickness of the cladding layer is 0.5-5 mm; and the length of the single-path cladding is 50-70 mm, the number of overlap times is 8-12, and the number of layers of the accumulating is 6-10.

Further, the preparation method further includes powder pretreatment and matrix pretreatment before the magnetic field stirring laser cladding molding technology.

The powder pretreatment includes the following steps: drying the aluminum-based amorphous alloy powder with a vacuum drying chamber with vacuum degree of 0.05-0.1 standard atmospheric pressure at the temperature of 100-120 DEG C through 1-1.5 h of thermal insulation.

The matrix pretreatment has the effect that: if the powder contains moisture, hydrogen is easily generated in the cladding process and is dissolved in the molten pool, while the solubility of the hydrogen in the aluminum alloy varies a lot with temperature, laser cladding has the characteristics of rapid heating and cooling, so that the hydrogen has no time to overflow and leaves in the cladding layer, thereby generating a large number of pores, so as to greatly lower the quality of the cladding layer.

The matrix pretreatment includes the following steps: ultrasonically cleaning the surface of the matrix with acetone and alcohol respectively for 15-20 min and preheating to the temperature of 100-150 DEG C before cladding.

Grease and impurities on the surface of the matrix can be removed through ultrasonic cleaning as the grease and the impurities have great impact on the combination of the cladding layer. However, the temperature gradient in the cladding process can be reduced through preheating, thereby reducing cracks.

The present invention has the positive effects that:

(1) the aluminum-based amorphous alloy powder adopted by the present invention has high degree of sphericity, good flowability and moderate particle size, and the added alloy elements have the characteristics of strong amorphous forming ability and stable structure, thus being suitable for preparation of the aluminum-based metallic glass cladding layer under the condition of laser cladding.

(2) the present invention adopts the magnetic field stirring laser cladding molding technology to prepare the aluminum-based metallic glass cladding layer and makes use of the characteristics of rapid heating and cooling, and an amorphous phase is formed when the cooling rate of the molten pool is greater than the critical cooling rate of amorphous forming of materials, so as to obtain an amorphous composite layer. Meanwhile, the stirring magnetic field in the horizontal direction is exerted on the cladding layer, so that solidified columnar or stripe-shaped dendritic crystals are difficult to grow up or are broken off and stirred into pieces to form new nucici-formation particles under the stirring action of non-contact force of the magnetic field, therefore, the solidification structure of the cladding layer is refined, in addition, the convection of the molten pool is enhanced, the temperature gradient is reduced, and the composition segregation is reduced, so as to achieve the objectives of improving the internal defect of the molten pool and enhancing the quality of the cladding layer; and the proportion of the defects such as the cracks, the pores and the like are no more than 1%.

(3) the content of the amorphous phase of the prepared aluminum-based metallic glass cladding layer is more than 30%, meanwhile, the aluminum-based metallic glass cladding layer has excellent mechanical property, wear resistance and corrosion resistance, the tensile strength can be restored to 100-130% of the original structure, and the microhardness can reach above 300 HV; and in 3.5% NaCl solution, the aluminum-based metallic glass cladding layer has higher self-corrosion potential and shows good corrosion-resistance ability; and the corrosion-resistance life can reach above 1,000 h in the neutral salt mist corrosion environment containing 3.5% NaCl. The aluminum-based metallic glass cladding layer can not only restore the structural strength of a light alloy damaged piece, but also provide effective surface protection and be widely applied in the fields of spaceflight, navigation and the like with comprehensive protection requirements.

### BRIEF DESCRIPTION OF DRAWINGS

FIG. 1 is an SEM (Scanning Electron Microscope) photograph of aluminum-based amorphous alloy powder adopted by an embodiment 1.

FIG. 2a is a back scattering photograph of a structure of the top of a cladding layer prepared by the embodiment 1.

FIG. 2b is a back scattering photograph of a structure of the top of a cladding layer prepared by a reference example 1.

FIG. 3a is a metallograph of a multi-path overlap position of the cladding layer prepared by the embodiment 1.

FIG. 3b is a partial enlarged drawing of the overlap position in FIG. 3a.

FIG. 3c is a metallograph of a multi-path overlap position of the cladding layer prepared by the reference example 1.

FIG. 3d is a partial enlarged drawing of the overlap position in FIG. 3c.

FIG. 4 is x-ray diffraction (XRD) spectrograms of the cladding layers and a complete amorphous ribbon that are prepared by the embodiment 1 and the reference example 1; in FIG. 4, 1 corresponds to the cladding layer of the embodiment 1, and 2 corresponds to the cladding layer of the reference example 1.

FIG. 5a is a DSC (Differential Scanning calorimetry) curve of the complete amorphous ribbon.

FIG. 5b is a DSC curve of the cladding layers prepared by the embodiment 1 and the reference example 1.

FIG. 6 are curves of friction coefficients along with time of the cladding layers and 5083 aluminum alloy matrixes that are prepared by the embodiment 1 and the reference example 1 under the condition of a test example 4.

FIG. 7 are potentiodynamic polarization curves of the cladding layers and the 5083 aluminum alloy matrixes that are prepared by the embodiment 1 and the reference example 1 in 3.5% NaCl solution.

### DETAILED DESCRIPTION

### Embodiment 1

Aluminum-based amorphous alloy powder adopted by an aluminum-based metallic glass cladding layer of the present embodiment consists of the following elements: 6 wt % of Ni, 4.5 wt % of Y, 2 wt % of Co, 1.5 wt % of La and Al as balance, i.e. Al₈₆Ni₆Y_{4.5}Co₂La_{1.5}.

The particle size range of the aluminum-based amorphous alloy powder is 25-71 mum, and the oxygen content is less than 1,000 ppm.

A Quanta 200 type environmental SEM configured with an EDS (Energy Dispersive Spectrometer) accessory is adopted for microstructure and morphology observation for the aluminum-based amorphous alloy powder; and an SEM photograph of the aluminum-based amorphous alloy powder is shown in FIG. 1.

It can be seen from FIG. 1 that: the aluminum-based amorphous alloy powder is spherical and has good flowability, and the surfaces of a part of large particles are bonded with a small amount of steel balls, which are beneficial for improving loading density of the powder and are suitable for an automatic powder feeding type cladding process.

A preparation method of the aluminum-based metallic glass cladding layer includes the following steps:

(1) powder pretreatment and matrix pretreatment:

drying the aluminum-based amorphous alloy powder with a vacuum drying chamber with vacuum degree of 0.08 standard atmospheric pressure at the temperature of 110 DEG C through 1.2 h of thermal insulation; and ultrasonic cleaning the surface of a 5083 aluminum alloy matrix with acetone and alcohol respectively for 18 min and preheating to the temperature of 120 DEG C before cladding.

(2) setting a cladding forming path: first, carrying out longitudinal single-path cladding, then choosing an appropriate amount of overlap for horizontal cladding, setting the length and overlap times of every single-path cladding according to the length and the width of the designed cladding layer, doing repeating motion and accumulating layer by layer, so as to form the cladding layer with a certain thickness finally,

wherein the amount of overlap is 30%, the dimension of the cladding layer is 60 mm*20 mm*1.2 mm, the length of the single-path cladding is 60 mm, the number of overlap times is 10, and the number of layers of accumulating is 8.

(3) the 5083 aluminum alloy matrix to be cladded is placed in an annular stirring magnetic field, so that the matrix generates a rotating magnetic field on the horizontal plane of a molten pool under the lasting stirring action of magnetic field force in a cladding forming process, so as to be capable of exerting the lasting stirring action of the magnetic field force on the molten pool, a coaxial powder-feed YG: Nd solid laser is vertical to the surface of the matrix, and a robot controls reciprocating motion for multi-path multi-layer cladding forming.

The specific process parameters are as follows: laser power: 2,000 W, scanning speed: 5.5 mm/s, spot diameter: 3 mm, powder feeding rate: 7 g/min, frequency of the magnetic field: 25 Hz and exciting current: 30 A.

### Reference Example 1

A reference example 1 is basically the same as the embodiment 1, and the different between the reference example 1 and the embodiment 1 is that: no magnetic field stirring is adopted in the step (3).

### Reference Example2

A reference example 2 is basically the same as the embodiment 1, and the different between the reference example 2 and the embodiment 1 is that: the particle size range of aluminum-based amorphous alloy powder in the reference example 2 is 75-100 mum.

### Text Example 1

### Micro-Morphologies of the Cladding Layers

An OLYMPUS-60 metallographic optical microscope (OM) is adopted for metallographic observation for the cross section of the cladding layer.

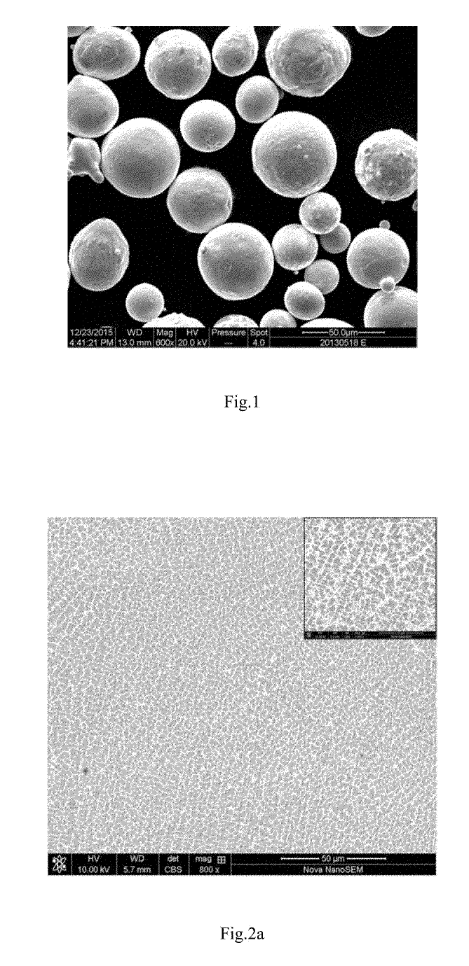

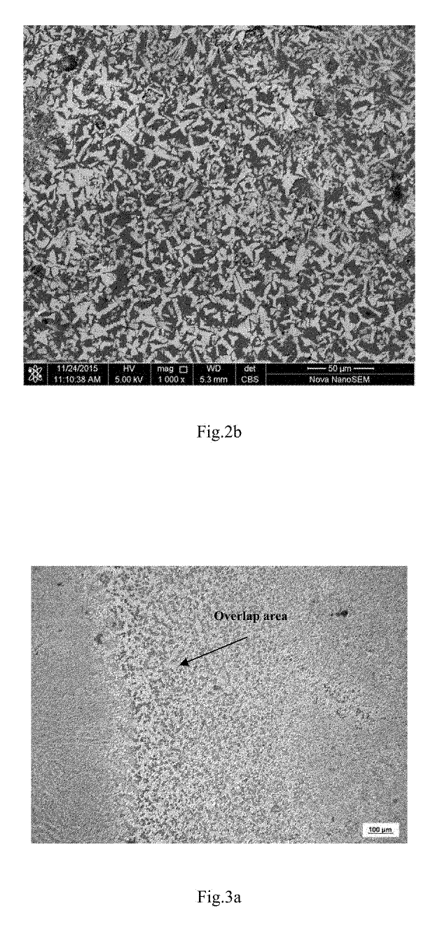

FIG. 2a and FIG. 2b are respectively a back scattering photograph of a structure of the top of the cladding layer prepared by the embodiment 1 and a back scattering photograph of a structure of the top of a cladding layer prepared by the reference example 1.

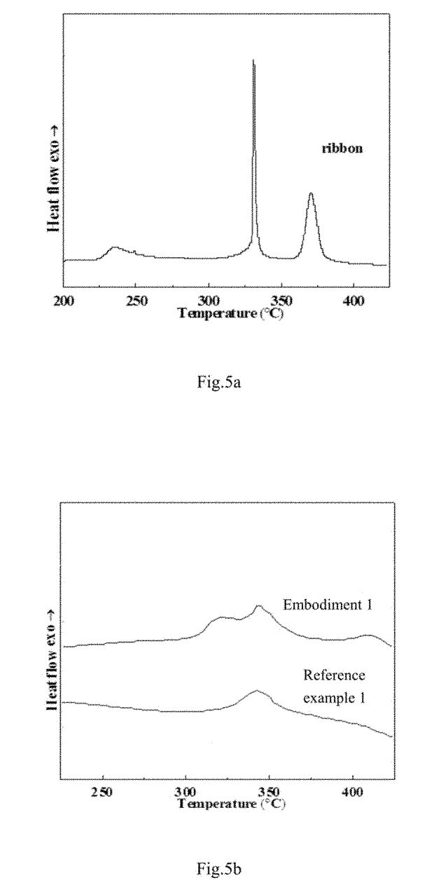

Through comparison between FIG. 2a and FIG. 2b, it can be found that: metallic compound phases such as Al—Ni—Y and the like inside the cladding layer of the reference example 1 constantly precipitates and grows in a melt cooling process to form a thicker and bigger snowflake-shaped dendritic structure, while the structure of the inside of the cladding layer of the embodiment 1 is that: a network structure is distributed on a spheroidized alpha-Al phase as the stirring action of the magnetic field is exerted on the inside of the cladding layer, and it can be known that the network structure is an amorphous phase according to XRD and DSC characterization analysis (with reference to FIG. 4 and FIG. 5b below).

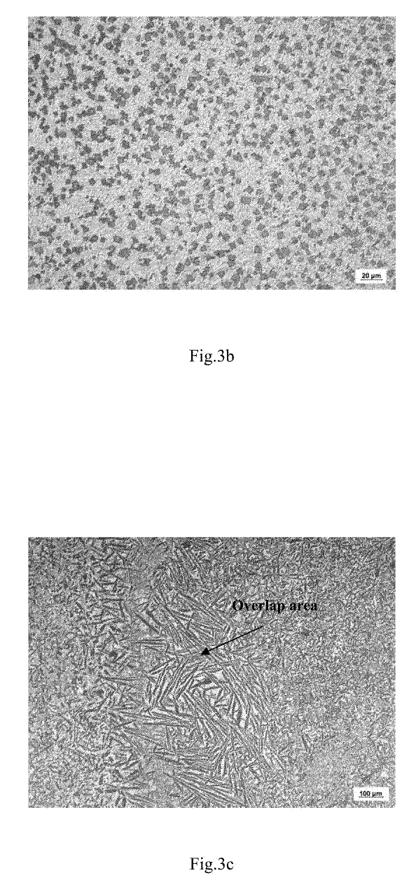

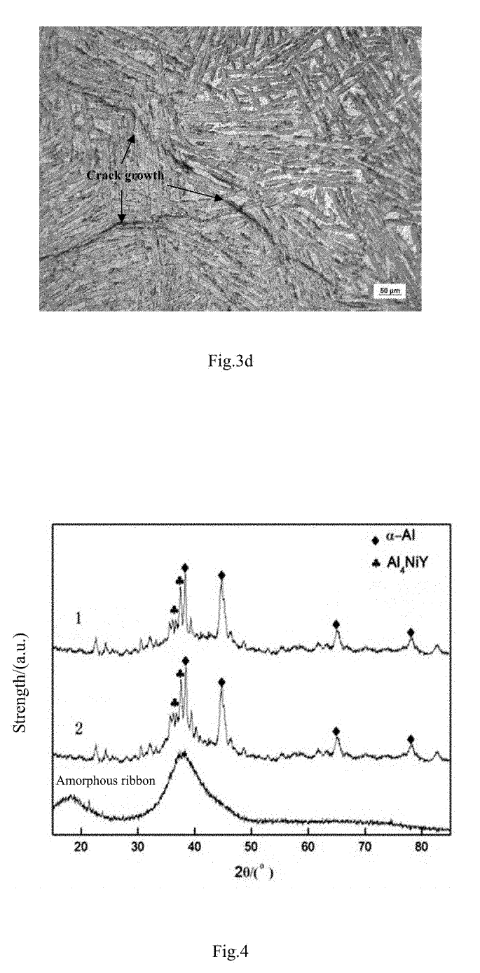

FIGS. 3a and 3b and FIGS. 3c and 3d are respectively a metallograph of a multi-path overlap position of the cladding layer prepared by the embodiment 1 and a metallograph of a multi-path overlap position of the cladding layer prepared by the reference example 1.

It can be seen from the figures that: dark blocky crystal grains are formed along the junctions of the network structure in an overlap area of the embodiment 1. It can be seen from a partial enlarged drawing that: the crystal grains the embodiment 1 are smaller in size and do not obviously grow up. While stripe-shaped dendritic crystals are formed in an overlap area of the reference example 1, and it can be seen from a partial enlarged drawing that: relative to an internal structure of the cladding layer, the size of the dendritic crystals is obviously increased. In the solidification process, as the temperature gradient of the junction of the overlap area and the former-path cladding layer is bigger, and crystal grains in the reference example 1 are bigger in size and have a certain degree of segregation, intermetallic compounds are easy to form at the junction based on the existing dendritic crystals and can constantly grow up along an element segregation area to form a thick and big dendritic crystal structure, the thick and big dendritic crystal structure grows up inwards the overlap area along the opposite direction of heat flow, and finally, stripe-shaped structures through the whole overlap area that are connected with each other are formed. As the formed stripe-shaped structures have large brittleness, and the stress is larger at the junctions at different positions and different directions, the stripe-shaped structures are easy to fracture to generate cracks and are easy to expand along the crystal boundary to form bigger cracks, thus seriously affecting the performance of the cladding layer.

After the stirring action of an added rotating magnetic field, on one hand, the temperature gradient is reduced, and the thermal stress is reduced; on the other hand, the growth of the blocky crystal grains formed at the junctions of the network structure is obviously inhibited, and the stress concentration is reduced, thus effectively inhibiting generation of the cracks and maintaining the stability of the structure of the whole cladding layers.

In order to measure the defects such as interspaces, black oxide inclusions, the cracks and the like in the cladding layers, ImageJ2× software is applied for processing images of cross sections of the cladding layers, calculating the proportion of the internal defects of the cladding layers and selecting average measured values of a plurality of areas, and the results are shown in Table 1.

### Text Example 2

### Microstructures of the Cladding Layers

A Rigaku D/max 2400 diffractometer made in Japan is adopted to test XRD spectrograms of the cladding layers and a complete amorphous ribbon that are prepared by the embodiment 1 and the reference example 1, which are shown in FIG. 4.

The diffractometer adopts a Cu Kalpha radiation source and is equipped with a monochromator, the power is 12 kW, the tube voltage is 50 kV, the current is 100 mA, and the stepping is 0.02.

Through comparison with the complete amorphous ribbon, it can be known that: the XRD spectrograms of the cladding layers of the reference example 1 and the embodiment 1 are basically the same (the spectrogram 1 represents the embodiment 1, and the spectrogram 2 represents the reference example 1.), the 2theta angle indicates that typical amorphous peaks exist at 30-50°, the strength is different, which indicates that the amorphous phases exist in the cladding layers, while crystallization phases are mainly metallic compound phases such as alpha-Al, Al₄NiY and the like.

### Text Example 3

### Heat Stability of the Cladding Layers

A Perkin-Elmer DSC-7 is adopted to characterize glass transition and crystallization behaviors of the cladding layers and the complete amorphous ribbon that are prepared by the embodiment 1 and the reference example 1, and DSC curves measured are respectively shown in FIG. 5a and FIG. 5b.

The detection conditions are: flowing protective high-purify argon gas with 0.05 L/min flow is pumped in, 20 DEG C/min of heating rate is adopted in a continuous heating mode, and the highest temperature is 1,200 DEG C.

It can be seen from FIG. 5a that: the complete amorphous ribbon has two obvious crystallization exothermic peaks and has a complete amorphous structure.

It can be seen from FIG. 5b that: the area of the exothermic peaks of the cladding layer prepared by the embodiment 1 is smaller than that of the complete amorphous ribbon, which indicates that a certain degree of crystallization and transition occurs in the preparation process of the cladding layer; the starting crystallization temperature is about 340 DEG C, which indicates that the cladding layer is stable at the temperature of below 340 DEG C, the crystallization process does not occur, and the cladding layer has good stability. The cladding layer prepared by the reference example 1 is basically the same as that prepared by the embodiment 1, but the area of crystallization exothermic peaks in the reference example 1 is reduced.

The amorphous contents of the cladding layers that are prepared by the embodiment 1 and the reference example 1 are respectively calculated according to the DSC curves, and the results are shown in Table 1.

### Text Example 4

### Wear Resistance of the Cladding Layers

ACETR UMT-3 type reciprocating friction testing machine is adopted, so that a GCr15 ball friction pair with 4mm of diameter and about 770 HV of hardness does reciprocating motion on a friction surface in a ball/surface contact manner, and samples are respectively the cladding layers and the 5083 aluminum alloy matrixes that are prepared by the embodiment 1 and the reference example 1.

The experimental operating conditions are: the reciprocating frequency is 5 Hz, the set load is 10 N, and the loading time is 20 min.

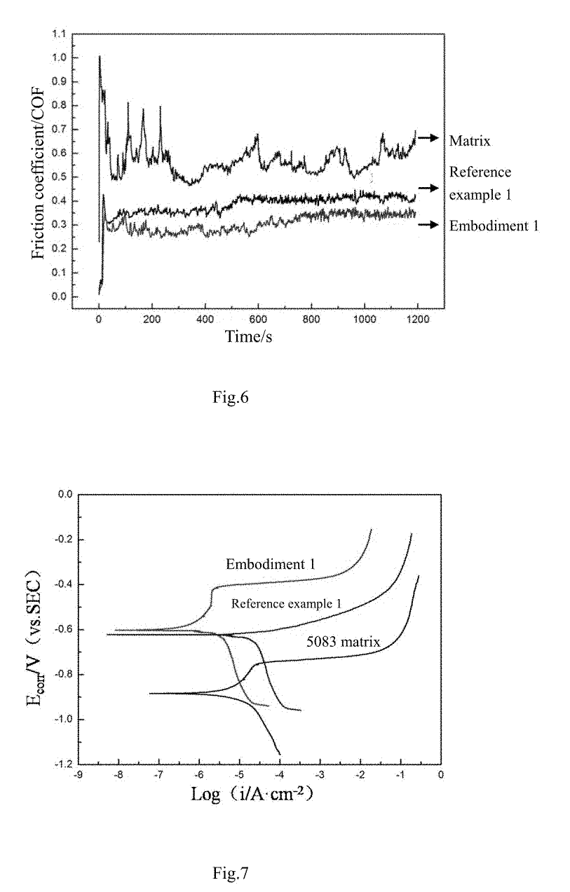

Curves of friction coefficients along with time of the cladding layers under a 10 N load at different scanning speeds are shown in FIG. 6, and the average friction coefficients of the cladding layers and the5083 aluminum alloy matrixes that are prepared by the embodiment 1 and the reference example 1 are respectively 0.288, 0.384 and 0.571 through calculation.

Therefore, it can be seen that: the friction coefficients of the cladding layers prepared by the embodiment 1 and the reference example 1 are less than the friction coefficients of the 5083 aluminum alloy matrixes prepared by the embodiment 1 and the reference example 1, and the embodiment 1 has the minimum friction coefficients, which indicates that the cladding layer prepared by the embodiment 1 has excellent anti-friction property.

The test results of the wear volumes are shown in Table 1.

### Text Example 5

### Wear Resistance of the Cladding Layers

An electrochemical integrated test system Potentiostat/Galvanostat (EG&G Princeton Applied Research Model 2273) is adopted to test the electrochemical properties of the cladding layers and the 5083 aluminum alloy matrixes that are prepared by the embodiment 1 and the reference example 1, and potentiodynamic polarization curves of the cladding layers and the 5083 aluminum alloy matrixes are shown in FIG. 7.

The testing conditions are as follows: the dimension of a sample is 10*10 mm, electrochemical potentiodynamic scanning is carried out in 3.5% NaCl solution, anodic polarization is carried out at the potential scanning rate of 0.333 mV/s, and the scanning is stopped until −100 mV_{SCE} or current density reaches 10⁻² A/cm².

It can be seen from FIG. 7 that: the cladding layer of the embodiment 1 has an obvious passivation behavior, the passivation current is lower, a passivation film is easy to form, the self-corrosion potential is high than that of the 5083 aluminum alloy matrix, and the self-corrosion current is lower than that of the 5083 aluminum alloy matrix, thus being capable of playing a good role in protecting the 5083 aluminum alloy matrix.

The cladding layer of the reference example 1 has many defects, thus causing poorer corrosion resistance as the cladding layer of the reference example 1 has bigger self-corrosion current than the aluminum alloy matrix and has no passivation range although the self-corrosion potential thereof is higher than that of the 5083 aluminum alloy matrix.

### Text Example 6

### Mechanical Property of the Cladding Layers

The cladding layers and the 5083 aluminum alloy matrixes that are prepared by the embodiment 1 and the reference example 1 are respectively processed into non-proportional drawing pieces according to a GB/T 228.1-2010 standard. According to the actual repair requirement, in order to test repair of the cladding layers for the strength of a structure-damaged part, along the thickness direction of each of drawing samples of the embodiment 1 and the reference example 1, one half is the cladding layer, and the other half is the 5083 aluminum alloy matrix.A drawing test is carried out by a CMT4304 type electronic all-purpose testing machine, the loading rate is 1 mm/min, the average values are obtained after the testing is completed, and the results of the drawing strength are shown in Table 1.

An HXD-1000 type microhardness tester is adopted to respectively carry out average microhardness tests for the surfaces of the cladding layers and the 5083 aluminum alloy matrixes that are prepared by the reference example 1 and the embodiment 1, the load is 100 g, the holding time is 10s, and the results are shown in Table 1.

TABLE 1

| | Embodi- | Reference | Reference | 5083aluminum |
|---|---|---|---|---|
| | ment 1 | example 1 | example 2 | alloy matrix |
| Defect proportion | 0.3% | 10.5% | 3.8% | — |
| Content of | 36.1% | 17.0% | 25.3% | — |
| amorphous phase | | | | |
| Friction coefficient | 0.288 | 0.384 | 0.321 | 0.571 |
| Wear volume | 2.516 | 5.027 | 3.234 | 45.638 |
| (10⁷ mum³) | | | | |
| Drawing strength | 289 MPa | 260 MPa | 275 MPa | 275 MPa |
| Microhardness | 385 HV | 244 HV | 288 HV | 75 HV |

### Embodiment 2-Embodiment 3

The embodiments 2 and 3 are basically the same as the embodiment 1, and the difference between the embodiments 2 and 3 and the embodiment 1 is the element composition of aluminum-based amorphous alloy powder, which is shown in Table 2 and Table 3.

TABLE 2

| | Embodiment 1 | Embodiment 2 | Embodiment 3 |
|---|---|---|---|
| Element composition | Al₈₆Ni₆Y_{4.5}Co₂La_{1.5} | Al₈₅Ni₅Y₆Co_{3.5}La_{0.5} | Al₈₄Ni₇Y_{4.5}Co_{1.5}La₃ |
| Defect proportion | 0.3% | 0.8% | 0.5% |
| Content of | 36.1% | 32.4% | 33.8% |
| amorphous phase | | | |
| Friction coefficient | 0.288 | 0.302 | 0.296 |
| Wear volume (10⁷ mum³) | 2.516 | 2.836 | 2.752 |
| Drawing strength | 289 MPa | 281 MPa | 286 MPa |
| Microhardness | 385 HV | 325 HV | 338 HV |

TABLE 3

| | Embodiment 4 | Embodiment 5 | Embodiment 6 |
|---|---|---|---|
| Element composition | Al₈₅Ni₈Y_{5.5}Co₁La_{0.5} | Al₈₅Ni₆Y₃Co₅La₁ | Al₈₅Ni_{6.5}Y_{4.5}Co₂La₂ |
| Defect proportion | 0.7 | 0.8% | 0.5% |
| Content of | 33.5% | 34.7% | 35.8% |
| amorphous phase | | | |
| Friction coefficient | 0.315 | 0.320 | 0.288 |
| Wear volume (10⁷ mum³) | 2.957 | 2.843 | 2.520 |
| Drawing strength | 280 MPa | 279 MPa | 288 MPa |
| Microhardness | 335 HV | 327 HV | 355 HV |

### Embodiment 4-Embodiment 5

The embodiments 4 and 5 are basically the same as the embodiment 1, and the difference between the embodiments 4 and 5 and the embodiment 1 is the specific process parameters of magnetic field stirring laser cladding molding, which is shown in Table4.

TABLE 4

| | Embodi- | Embodi- | Embodi- | Embodi- | Embodi- | Embodi- |
|---|---|---|---|---|---|---|
| | ment 1 | ment 7 | ment 8 | ment 9 | ment 10 | ment 11 |
| Laser power | 2000 W | 1700 W | 1900 W | 2200 | 2300 | 2400 |
| Scanning speed | 5.5 mm/s | 3.5 mm/s | 5 mm/s | 6 mm/s | 6.5 mm/s | 7 mm/s |
| Spot diameter | 3 mm | 3 mm | 3 mm | 3 mm | 3 mm | 3 mm |
| Powder feeding rate | 7 g/min | 6 g/min | 6.5 g/min | 7 g/min | 7.5 g/min | 8 g/min |
| Frequency of magnetic | 25 Hz | 15 HZ | 35 Hz | 20 Hz | 25 Hz | 25 Hz |
| field | | | | | | |
| Exciting current | 30 A | 10 A | 20 A | 40 A | 50 A | 30 A |
| Defect proportion | 0.3% | 0.4% | 0.6% | 0.8% | 0.7% | 0.9% |
| Content of amorphous | 36.1% | 34.1% | 32.7% | 36.5% | 31.5% | 32.1% |
| phase | | | | | | |
| Friction coefficient | 0.288 | 0.299 | 0.306 | 0.285 | 0.314 | 0.325 |
| Wear volume | 2.516 | 2.793 | 2.673 | 2.420 | 2.844 | 3.028 |
| (10⁷ mum³) | | | | | | |
| Drawing strength | 289 MPa | 285 MPa | 283 MPa | 298 MPa | 278 MPa | 269 MPa |
| Microhardness | 385 HV | 332 HV | 350 HV | 380 HV | 342 HV | 335 HV |

The relevant properties of the cladding layers prepared by the reference example 2 and the embodiment 2-embodiment 11 according to the methods of the test examples 1, 3, 4 and 6, and the results are respectively shown in Table 1-Table 4.

1. An aluminum-based metallic glass cladding layer, characterized in that: the aluminum-based metallic glass cladding layer takes aluminum-based amorphous alloy powder as a raw material and is prepared by a magnetic field stirring laser cladding molding technology, wherein the aluminum-based amorphous alloy powder consists of the following elements: 5 wt %-8 wt % of Ni, 3 wt %-6 wt % of Y, 1 wt %-5 wt % of Co, 0.5 wt %-3 wt % of La and Al as balance.

2. The aluminum-based metallic glass cladding layer according to claim 1, characterized in that: the particle size range of the aluminum-based amorphous alloy powder is 25-71 mum.

3. The aluminum-based metallic glass cladding layer according to claim 1, characterized in that:
the oxygen content of the aluminum-based amorphous alloy powder is below 1,000 ppm.

4. The aluminum-based metallic glass cladding layer according to claim 1, characterized in that:
the aluminum-based amorphous alloy powder consists of the following elements: 6 wt %-7 wt % of Ni, 4 wt %-5 wt % of Y, 2 wt %-3 wt % of Co, 1 wt %-2 wt % of La and Al as balance.

5. A preparation method of an aluminum-based metallic glass cladding layer, characterized in that: according to the preparation method, the aluminum-based amorphous alloy powder is cladded on a matrix by the magnetic field stirring laser cladding molding technology; and
the specific methods are described as follows: the matrix to be cladded is placed in an annular stirring magnetic field, so that the matrix generates a rotating magnetic field on the horizontal plane of a molten pool under the lasting stirring action of magnetic field force in a cladding forming process, so as to be capable of exerting the lasting stirring action of the magnetic field force on the molten pool, a coaxial powder-feed YG: Nd solid laser is vertical to the surface of the matrix, and a robot controls reciprocating motion for multi-path multi-layer cladding forming.

6. The preparation method of the aluminum-based metallic glass cladding layer according to claim 5, characterized in that: the specific process parameters of the magnetic field stirring laser cladding molding technology are as follows: laser power: 1,700-2,400 W, scanning speed:

3. 5-7 mm/s, spot diameter: 3 mm, powder feeding rate: 6-8 g/min, frequency of the magnetic field: 15-35 Hz, exciting current: 10-50 A, cladding time at every time: 10-15 s and cladding interval: 120-180 s.

7. The preparation method of the aluminum-based metallic glass cladding layer according to claim 5, characterized in that: the magnetic field stirring laser cladding molding technology also includes setting a cladding forming path: first, carrying out longitudinal single-path cladding, then choosing an appropriate amount of overlap for horizontal cladding, setting the length and overlap times of every single-path cladding according to the length and the width of the designed cladding layer, doing repeating motion and accumulating layer by layer, so as to form the cladding layer with a certain thickness finally.

8. The preparation method of the aluminum-based metallic glass cladding layer according to claim 7, characterized in that: in the setting of the cladding forming path, the amount of overlap is 30%-50%; the length of the cladding layer is 50-70 mm, the width of the cladding layer is 15-25 mm, and the thickness of the cladding layer is 0.5-5 mm; and the single-path cladding length is 50-70 mm, the number of overlap times is 8-12, and the number of layers in accumulating layer by layer is 6-10.

9. The preparation method of the aluminum-based metallic glass cladding layer according to claim 5, characterized in that: the preparation method further includes powder pretreatment and matrix pretreatment before the magnetic field stirring laser cladding molding technology:
the powder pretreatment includes the following steps: drying the aluminum-based amorphous alloy powder with a vacuum drying chamber with vacuum degree of 0.05-0.1 standard atmospheric pressure at the temperature of 100-120 DEG C through 1-1.5 h of thermal insulation; and the matrix pretreatment includes the following steps: ultrasonic cleaning the surface of the matrix with acetone and alcohol respectively for 15-20 min and preheating to the temperature of 100-150 DEG C before cladding.
